(19) United States
(12) Patent Application Publication
(10) Pub. No.: US 2010/0223641 A1
(43) Pub. Date: Sep. 2, 2010

(54) System and method for predicting the optimum delivery of multimedia content based on human behavior patterns

(76) Inventor: Robert B. Hubbard, Marina Del Rey, CA (US)

Correspondence Address: Benman, Brown & Williams;Suite 2740, 2049 Century Park East, Los Angeles, CA, 90067, US

(21) Appl. No.: 12/380,486

(22) Filed: Feb. 27, 2009

(51) Int. Cl. H04N 7/10; G06Q 30/00

(52) U.S. Cl. 725/35; 705/14.49

(57) ABSTRACT

A system for optimizing the delivery of multimedia content to subscribers' devices. The novel system includes a first sub-system for obtaining data on subscribers' actions on their devices and a second sub-system for recommending a delivery solution for new content based on the obtained data. In an illustrative embodiment, the second sub-system includes a neural network artificial intelligence engine adapted to predict how subscribers will respond to new content based on their monitored responses to previous content, and identify subscribers predicted to have a positive response to the new content. Optionally, the second sub-system may also identify one or more subgroups of subscribers predicted not to have a positive response to the new content and recommend modifications to the content to improve the response of these subscribers.

### BACKGROUND OF THE INVENTION

1. Field of Invention

The present invention relates to communications systems. More specifically, the present invention relates to systems and methods for delivering multimedia content to media storage devices.

2. Description of the Related Art

Advertisers generally want to target their advertisements toward the individuals who are most likely to respond favorably to their ads (by, for example, purchasing the advertised product). At the same time, most consumers prefer to receive advertisements that fit with their personal interests, to learn about new products and services or promotions and sales on things they might want to purchase, and some consumers would prefer not to receive any advertisements at all. It would therefore be desirable to be able to deliver advertisements to specific targeted consumers based on their personal interests and predicted responses. This, however, is difficult if not impossible to accomplish using conventional advertising practices.

Most conventional advertising mediums - such as television or radio commercials, print ads in newspapers or magazines, and banners ads on Internet websites—rely on a “spray and pray” approach where advertisements are broadcast or otherwise presented to a large general audience in hopes that some of the people who receive the ad will respond favorably. This approach can be inefficient and unreliable since there is no way to control who will receive the ad.

Advertisers typically use general demographic assumptions on the type of people who might be viewing a particular television show, magazine, website, etc., to help determine where to place an ad. These assumptions usually are not very accurate, resulting in advertisements being viewed by people who have no interest in them, while people who might have been interested never see them. Furthermore, even if desirable target consumers are watching the selected television show, for example, there is no guarantee that they will actually watch the commercials.

Direct mail, email, and telemarketing offer advertisers the ability to target specific individuals. However, these types of advertisements are usually unsolicited and unwanted, and are often discarded or ignored by the recipient. In addition, there is no way of accurately predicting how a particular individual will respond to an ad other than relying on loose assumptions of the person's interests based on how the individual's address or phone number was obtained (credit card purchases, catalog requests, etc.).

Hence, a need exists in the art for an improved system or method for delivering advertisements to targeted consumers that is more efficient than conventional practices.

### SUMMARY OF THE INVENTION

The need in the art is addressed by the system and method for optimizing the delivery of multimedia content to subscribers' devices of the present invention. The novel system includes a first sub-system for obtaining data on subscribers' actions on their devices and a second sub-system for recommending a delivery solution for new content based on the obtained data. In an illustrative embodiment, the delivery solution includes the selection of which subscribers should be sent the new content to maximize the predicted acceptance of that content. The second sub-system includes a neural network artificial intelligence engine adapted to predict how subscribers will respond to new content based on their monitored responses to previous content, and identify subscribers predicted to have a positive response to the new content. Optionally, the second sub-system may also identify one or more subgroups of subscribers predicted not to have a positive response to the new content and recommend modifications to the content to improve the response of these subscribers.

### BRIEF DESCRIPTION OF THE DRAWINGS

FIG. 1 is a simplified block diagram of a system for delivering multimedia content to media storage devices designed in accordance with an illustrative embodiment of the present invention.

FIG. 2 is a simplified flow diagram of a provider-side sub-system designed in accordance with an illustrative embodiment of the present invention.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

The present invention provides a novel system for delivering multimedia content to personal media storage devices. In an illustrative embodiment, advertisements (or other types of multimedia content) are delivered to specific individuals via their cellular phones. The system may also be adapted for use with other types of media storage devices such as personal digital assistants (PDAs), MP3 players, gaming consoles, satellite radio receivers, digital television receivers, GPS navigation devices, or any other personal device with a processor, memory, and communication capability. Advertising via cellular phones offers advertisers the ability to target specific individuals, since cellular phones are typically personal devices used primarily by one person. Cellular phones are also more often with the consumer as compared to other advertising mediums such as televisions, and also offer displays and processing power capable of playing high quality multimedia content.

In a preferred embodiment, in order to avoid unsolicited spamming, consumers must opt-in or subscribe to the advertising service to receive ads via their cellular phones. In exchange, the consumers, or “subscribers”, may receive free or discounted products or services such as airtime, phones, music or game downloads, etc. Upon signing up for the service, subscribers are asked to create a subscriber profile that includes general demographic information (such as age, gender, etc.) as well as their personal preferences on the categories of ads they would prefer to receive (such as, for example, entertainment, sports, food, etc.). The advertising system then uses this information to select which subscribers receive which advertisements.

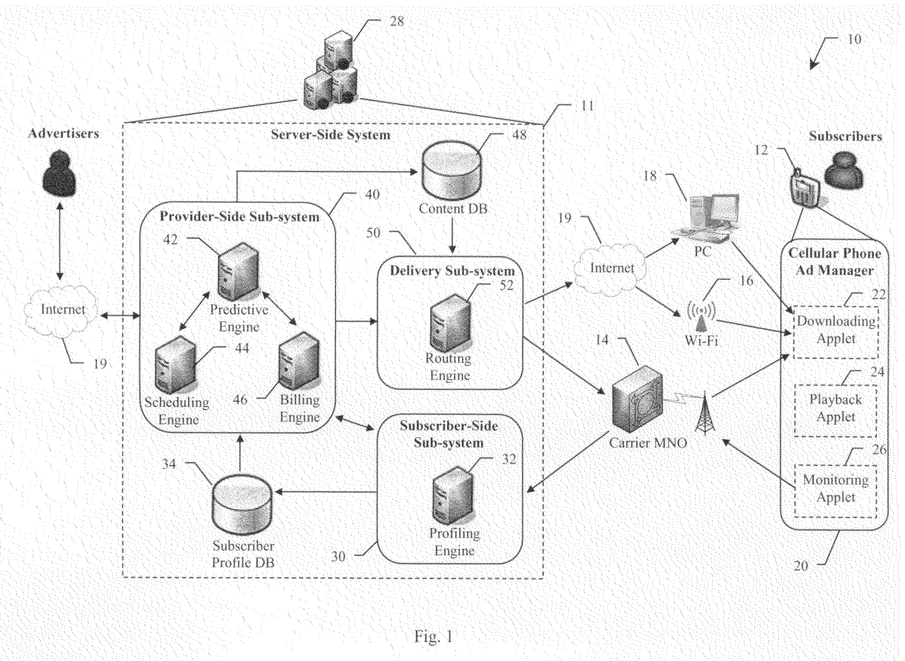

FIG. 1 is a simplified block diagram of a system 10 for delivering multimedia content to media storage devices designed in accordance with an illustrative embodiment of the present invention. In the illustrative embodiment, the system 10 includes a server-side system 11 adapted to deliver advertising content (preferably high quality multimedia ads, similar to television commercials) provided by the advertisers (or content providers) to subscribers via their cellular phones 12. For simplicity, only one phone 12 is shown in FIG. 1. In the illustrative embodiment of FIG. 1, the server-side system 11 and phone 12 can communicate via carrier (through a mobile network operator 14) or a Wi-Fi connection 16, or by connecting the phone 12 to a computer 18 that is connected to the internet 19. Other communications protocols may also be used without departing from the scope of the present teachings.

The advertising service provides each phone 12 with an “ad manager” program 20, which is client-side software stored in the phone's internal memory and executed by the phone's processor. The ad manager 20 includes a downloading applet 22 that manages the downloading and storing of ads received from the advertising system 10. In a preferred embodiment, the advertising system 10 embeds a scheduled playback time with each transmitted ad. Ads may be transmitted to the phone 12 at any time prior to the scheduled playback time. The downloading applet 22 stores the ads in the phone's memory until they are viewed by the subscriber. The downloading of ads is preferably invisible to the subscriber and does not interrupt or otherwise affect normal phone usage.

The phone ad manager 22 also includes a playback applet 24 that manages the playback of the ads. At the scheduled playback time, the playback applet 24 indicates on the phone's display that an ad is available for viewing. The subscriber can choose to watch the ad at that time, or save it to watch later. In a preferred embodiment, after an ad is played, the playback applet 24 initiates a procedure for confirming that the subscriber actually watched the ad. For example, the applet 24 may display instructions on the screen to press a particular keypad within a particular amount of time (say, for example, ten seconds). If the subscriber follows the instructions within the allotted time, he is awarded credits for watching the ad. The credits can then be used for purchasing goods or services. This procedure allows the system 10 to confirm to the advertiser not only that the ad was displayed, but also that the subscriber was actually watching it.

In accordance with the present teachings, the ad manager 20 also includes a monitoring applet 26 for monitoring the subscriber's behavior, particularly his response to ads. The monitoring applet 26 may record, for example: whether an ad was downloaded successfully, at what time the ad was played, whether the subscriber watched the ad in its entirety (as indicated by his following of the subsequent screen instructions as described above), whether the ad was saved, the user's actions after viewing the ad, etc.

Each ad preferably includes one or more ways to measure or determine the user's response to the ad (e.g., whether or not the user had a positive response to the ad). In an illustrative embodiment, some ads may be followed with a query, such as “Did you like this ad?”, which indicates whether his response to the ad was positive or negative. This query may be combined with the confirmation procedure discussed above (i.e., the user is instructed to answer the query within the allotted time in order to receive credit for watching the ad).

In addition, some ads may include an offer from the advertiser, such as a coupon for free or discounted goods or services. The playback applet 24 gives the subscriber the option of deleting the offer, or saving it. The coupon may include a code that can be entered at online stores and/or a barcode that can be displayed on the phone and scanned by a merchant to receive the advertised offer. In a preferred embodiment, a unique code is given to each subscriber. When the code is used at a store, data is transmitted from the store to the advertising system 10, confirming that the code was used. This allows the system 10 to track which subscribers actually use their coupons and also when they use the coupons (use of a coupon indicates a favorable response to the ad).

Other methods may also be used to help the system 10 determine whether or not a subscriber responds favorably to an ad. For example, certain actions made by the user (such as initiating a search for the nearest store, visiting an advertised website or calling an advertised phone number, saving an ad, forwarding an ad to a friend, etc.) after viewing an ad may indicate a positive response.

In a preferred embodiment, the monitoring applet 26 also monitors and records other subscriber behavior patterns, such as phone usage, phone location, web browsing, purchases made via the phone, methods used to access or communicate digital information (e.g., Bluetooth, Wi-Fi, USB, etc.), and any other recordable metrics that may be useful to the system 10 for modeling the subscriber's behavior and predicting how he will respond to future ads. The monitoring applet 26 accumulates and saves the subscriber's behavior patterns and responses to ads in a data file and transmits the file to the server-side system 11 periodically (such as once a day). In the illustrative embodiment of FIG. 1, the monitored data files are transmitted from the phone 12 to the server 11 via carrier; however, the data may also be transmitted via Wi-Fi, satellite, USB, or any other communication method without departing from the scope of the present teachings.

In accordance with the present teachings, the advertising system 10 includes a server-side system 11 that uses the data obtained by the monitoring applet 26 to optimize the delivery of ads to the subscribers, by recommending the best subscribers to receive a particular ad, the best time to schedule an ad, the price for delivering the ad, and the best time and method to transmit the ads to the phones. In an illustrative embodiment, the server-side system 11 is implemented in software stored in and executed by a bank of servers 28.

The server-side system 11 includes a subscriber-side sub-system 30, a provider-side sub-system 40, and a delivery sub-system 50, plus a subscriber profile database 34 and a content database 48. The subscriber-side sub-system 30 receives the data monitored by the cellular phones 12 and uses the data to update a profile on each subscriber. The subscriber profiles are then stored in the subscriber profile database 34. Each subscriber profile includes information about the subscriber's demographic details and personal preferences, as well as his recorded behavior patterns and responses to ads. The provider-side sub-system 40 uses the subscriber profiles to help the advertisers (the content providers) refine their advertising campaigns, including the selection of which subscribers should be targeted to receive their ads, which are stored in the content database 48. The delivery sub-system 50 then uses the recorded subscriber behavior patterns to determine the optimal time and routing method to transmit the ads to the cellular phones 12 of each selected subscriber.

The subscriber-side sub-system 30 receives the monitored data from each phone 12, and may also receive data from other sources such as merchants (regarding, for example, coupon use as discussed above) or a website that allows subscribers to manually modify their personal preferences and demographic information. In an illustrative embodiment, each subscriber's profile is generated when the subscriber first registers for the advertising service. The subscriber is asked to provide some basic demographic information (age, gender, location, etc.) and ad category preferences (sports, politics, music, etc.). This information may be obtained, for example, through a website, entered manually on a registration form, or transmitted by the phone. As the subscriber uses the advertising service, more information about the subscriber is collected by the monitoring applet 26. The monitoring applet 26 periodically transmits the collected data to the subscriber-side sub-system 30. The subscriber-side sub-system 30 sifts through the data received from each phone 12 and saves relevant information to the subscribers' profiles. The profile therefore provides a more accurate model of the subscriber's preferences and behavior patterns the more he uses the service.

In a preferred embodiment, the subscriber-side sub-system 30 includes a profile refining engine 32 for automatically refining the subscribers' personal preferences based on the subscribers' behavior patterns and responses to ads. In a particular embodiment, the subscriber is asked to specify only a few personal preferences upon registration, and the profiling engine 32 automatically refines the subscriber's preferences to greater detail based on their responses to ads. For example, subscribers may be asked upon registration whether or not they are interested in certain general categories, such as music, movies, sports, food, etc. Over time and continued use of the advertising system, the profiling engine 32 will refine the subscribers' profiles to include more details about their interests. For example, if a subscriber initially indicated that he liked sports, the profiling engine 32 may eventually determine, based on his response to various ads, which sports he likes, which teams he prefers, who his favorites athletes are, etc. The more detailed profiles can help the provider-side sub-system 40 to more accurately predict how the subscriber will respond to future ads. For a more detailed description of an illustrative subscriber-side sub-system 30 and profiling engine 32, see co-pending patent application entitled “SYSTEM AND METHOD FOR INTELLIGENTLY MONITORING SUBSCRIBER'S RESPONSE TO MULTIMEDIA CONTENT”, by R. B. Hubbard (Atty. Docket No. Hubbard-2), the teachings of which are incorporated herein by reference.

In operation, advertisers interact with the provider-side sub-system 40 to upload their ads to the content database 48 and specify the parameters of their advertising campaign, including the demographics they want to reach and when they want to schedule their ads for playback. The provider-side sub-system 40 uses the subscriber profiles stored in the subscriber database 34 to provide the advertisers with intelligent information about the specific individual behavior patterns of each subscriber as to their approval/acceptance or disapproval/rejection of particular advertising campaigns, and makes recommendations on an optimal advertising campaign. The advertisers may choose to use the system recommendations or override them and use their own campaign parameters.

In an illustrative embodiment, the provider-side sub-system 40 includes a predictive engine 42 for predicting how subscribers will respond to a particular advertising campaign based on their personal preferences and recorded behavior patterns stored in the profile database 34, and recommending an optimal campaign solution that maximizes the predicted subscriber acceptance of the campaign. In particular, the predictive engine 42 identifies the “high uptake” subscribers that are predicted to have a high probability of having a positive response to a particular ad campaign. The predictive engine 42 may also make recommendations on how to modify the campaign parameters in order to improve the predicted acceptance of an ad by selected “low uptake” subscribers (subscribers predicted to have a low probability of having a positive response to the ad campaign).

The provider-side sub-system 40 may also include a scheduling engine 44 for recommending the best time to schedule an ad based on subscriber behavior patterns. In a preferred embodiment, the scheduling engine 44 recommends the best time slot that matches when the subscribers in the targeted demographic prefer to watch their ads, based on their monitored usage patterns (such as at what times the subscriber has previously watched his ads), which are recorded by the monitoring applet 26. An illustrative scheduling engine 44 suitable for this application is described in a co-pending patent application entitled “SYSTEM AND METHOD FOR OPTIMIZING THE SCHEDULING OF MULTIMEDIA CONTENT”, by R. B. Hubbard (Atty. Docket No. Hubbard-4), the teachings of which are incorporated herein by reference.

The provider-side sub-system 40 may also include a billing engine 46 for automatically computing the cost to the advertiser for a particular campaign. In a preferred embodiment, the billing engine 46 sets the price of an ad campaign for an advertiser based on ad type, frequency and volume of ads to be sent, campaign duration, and the acceptance rate of the targeted subscribers. An illustrative billing engine 46 is described in a co-pending patent application entitled “SYSTEM AND METHOD FOR OPTIMIZING THE PRICING OF MULTIMEDIA CONTENT DELIVERY”, by R. B. Hubbard (Atty. Docket No. Hubbard-5), the teachings of which are incorporated herein by reference.

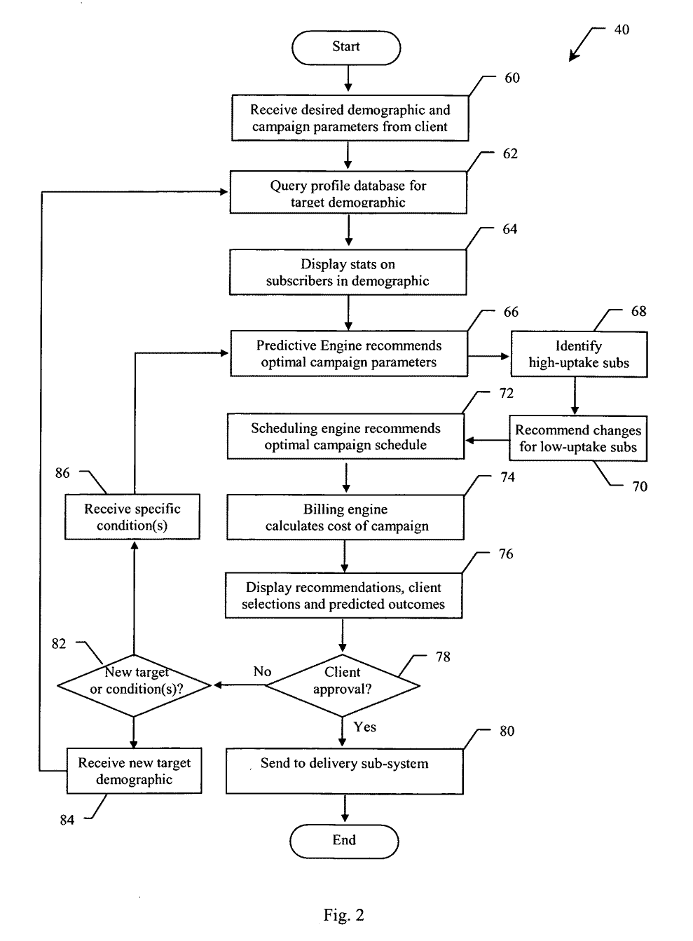

FIG. 2 is a simplified flow diagram of a provider-side sub-system 40 designed in accordance with an illustrative embodiment of the present invention.

First, at Step 60, the provider-side sub-system 40 receives the desired demographic and campaign parameters from the advertiser. In an illustrative embodiment, the system 40 includes a web interface for interacting with the advertiser. Other types of user interfaces may also be used without departing from the scope of the present teachings. The web interface allows the advertiser to upload ad content (which is then stored in the content database 48) and to specify the desired demographic (for example, men and women, aged 18-34, who like football) for the advertising campaign. The advertiser may also provide other campaign parameters (such as how long and how often they want the ad to run, preferred playback times, any associated coupons or offers, etc.) and ad characteristics (such as the length of the ad, type of product or service being advertised, etc.).

Next, at Step 62, the provider-side sub-system 40 queries the profile database 34 for subscribers that fit the target demographic, and at Step 64, displays statistics on the returned subscribers to the advertiser. The displayed statistics includes the total number of subscribers in the requested demographic and may also include additional statistical information about the group such as age ranges, gender, regional location, and system usage patterns (e.g., times they typically watch ads, average number of ads watched per day, how often they use coupons sent with ads, when they use coupons, talk time, text messaging usage patterns, how often their profile changes, types of profile changes, and other key performance indicators that may help the advertisers refine their campaign for higher success).

In a preferred embodiment, only subscribers whose profiles indicate acceptance of the type of ad will be returned in the query. For example, if a subscriber's profile indicates that he does not like political ads, that subscriber will not be returned in any queries for a political type ad, regardless of whether he fits the advertiser's desired demographic. This implies a sensitivity to the consumer that is absent in conventional advertising. By giving advertisers access (subscribers remain anonymous) to the personal preferences of a group of subscribers, or even a single individual, a system is presented whereby a seemingly personal relationship is established between advertiser and consumer. This relationship can then be tracked against advertising dollars spent to revenue generated.

At Step 66, the predictive engine 42 determines the optimal campaign solution based upon the requested target attributes. In an illustrative embodiment, the predictive engine includes Steps 68 and 70. At Step 68, the predictive engine 42 identifies the high-uptake subscribers in the target demographic, i.e., those subscribers predicted to have a high probability of having a positive response to the ad campaign, and recommends sending the ad to this group of subscribers for an optimal outcome.

Optionally, at Step 70, the predictive engine 42 may recommend modifications to the campaign that are predicted to improve the likelihood of higher acceptance by selected low-uptake subscribers. The recommendations may include changes to the campaign parameters, such as adding a coupon or offer, type of coupon, campaign duration, ad frequency, etc., and/or to the contents of the ad itself, such as the length of the ad, the tone of the ad (e.g., humorous or serious), etc. The predictive engine 42 may identify one or more subgroups of the low-uptake subscribers and one or more modifications for each subgroup. For example, the engine 42 may predict that a particular subgroup of low-uptake subscribers is more likely to respond favorably to the ad if the advertiser offers a “percent off” coupon instead of a “buy one get one free” coupon as originally specified. The system 40 would then recommend sending the ad with the original coupon offer to the high-uptake group of subscribers, and sending the ad with a “percent off” coupon to the identified subgroup of low-uptake subscribers.

In a preferred embodiment, the predictive engine 42 is an artificial intelligence engine implemented using a neural network comprised of a plurality of interconnected neural nodes. The output of each neural node is a weighted sum of its inputs, and the weights of the inputs are adaptive, changing based on the information presented to the network during a training mode. In accordance with the present teachings, the neural network 42 is trained by the subscriber-side sub-system 30 using the data stored in the profile database 34 on the subscribers' monitored behavior and responses to previous ads. The subscriber-side sub-system 30 includes an algorithm for determining the weights for the neural network 42 based on the subscriber's behavior and responses, and saves the weights to the subscriber's profile. When new subscriber data is received by the subscriber-side sub-system 30, new weights are calculated and the profile is updated accordingly. Thus, the predictive engine 42 adapts to changes in the subscribers' preferences and behavior patterns.

By presenting the neural network 42 with data on how the subscribers responded to previous ads, the predictive engine 42 can model the subscribers' behavior and predict how they will respond to new ads. In a preferred embodiment, the neural network 42 estimates the probability that a subscriber will have a positive response to an ad based on characteristics of the ad (including the ad type/category and the specific product or service being advertised) and ad campaign. The neural network 42 may also be designed to search for patterns in the subscribers' behavior and prior responses that may be used to modify the ad or ad campaign parameters in order to improve the subscribers' responses.

The first step to developing a neural node is to identify what adaptive functions the node is expected to perform. This is accomplished by creating a “rule set” to test the conditions of the business process. A rule set is essentially code that can be extracted into any preferred language, such as C++ or C#, as a set of hard-coded programmatic instructions with the ability to adjust its behavior related to changes in the environment in which it is monitoring. Once the rule set is determined and tested to meet all conditions, a stable engine then exists. It is at this point that the adaptive neural node can be created.

The predictive engine 42 has to perform these tasks for potentially millions of subscribers on a minute-by-minute basis to improve the experience for both the advertiser and the targeted subscriber. This is a high performance, highly adaptive task that needs an adaptable engine that has hard-coded “base” rules to work from, and then change as needed on its own, based on the behavior patterns of the targeted subscribers.

Returning to FIG. 2, at Step 72, the scheduling engine 44 identifies the optimal time(s) to schedule the ad based on the subscriber behavior patterns. The scheduling engine 44 may divide the targeted subscribers into subgroups, each subgroup having a different optimal timeslot. For example, one group may respond better to lunch hour ads, while a second group may respond better to dinnertime ads.

At Step 74, the billing engine 46 calculates how much to bill the advertiser for the specified campaign, considering the targeted subscribers (as recommended by the predictive engine 42 or manually selected by the advertiser if the advertiser chooses to override the system recommendations) and the playback schedule (recommended by the scheduling engine 44 or manually selected by the advertiser). If the scheduled time conflicts with a previously scheduled ad, the advertiser may select another timeslot or the billing engine 46 can initiate a bidding process between the advertisers who want that particular slot.

At Step 76, the provider-side sub-system 40 displays to the advertiser the recommended campaign (including, for example, the number of subscribers in the recommended “high-uptake” group, the number of subscribers in the selected “low-uptake” subgroup(s), and the recommended modifications for improving the response of the “low-uptake” subscribers), the predicted outcome of the campaign (which may include, for example, a number indicating the percentage of subscribers predicted to accept the ad), and the cost for the recommended campaign.

At Step 78, the advertiser can either approve the recommended campaign and at Step 80, send it to the delivery sub-system 50, or at Step 82, the advertiser can choose to make manual adjustments to the campaign. In the illustrative embodiment, at Step 84, the advertiser can choose to select a different target demographic (for example, selecting a different geographic region, or a different age range) and repeat the process from Step 62, or at Step 86, the advertiser can input one or more specific conditions that will override the system recommendations. For example, the advertiser may specify a specific number of subscribers that he wants to target (such as the 100,000 best subscribers in the target demographic), or a specific playback time (e.g., the ad must run on Thursday at 11:00 am), or a maximum cost for the campaign. The system 40 then returns to Step 66, and makes new recommendations taking into account the override conditions requested by the advertiser.

In a preferred embodiment, at Step 76, the system 40 displays the predicted outcomes of both the original system recommendations, and the new campaign with the advertiser's requested conditions. At Step 78, the advertiser can accept the new campaign, decide to go back to the original system recommendations, or continue to manually adjust the campaign until satisfied.

After the advertiser has approved the campaign, at Step 80, the ad (including information about the scheduled playback times and any associated coupons or offers) is sent to the targeted subscribers by the delivery sub-system 50. In an illustrative embodiment, the ad may also include a question added by the subscriber-side sub-system 30 for use in refining the subscriber profiles.

In an illustrative embodiment, the ads may not be sent to the subscribers immediately after approval by the advertiser. Instead, they are stored until the delivery sub-system 30 is ready to transmit them. In a preferred embodiment, the delivery sub-system 50 includes a routing engine 52 that determines the best time and method for transmitting ads to the cellular phones 12. Certain phones are capable of communicating using more than one form of data transmission. For example, a dual-mode phone may be equipped to communicate using a cellular network or a Wi-Fi network, which is typically cheaper and faster than cellular transmission. In a preferred embodiment, the routing engine 52 analyzes a subscriber's behavior patterns, particularly relating to his locations and the transmission methods available at those locations, to determine the best predicted time and routing method to send ads to the subscriber in order to minimize transmission costs. An illustrative routing engine 52 is described in a co-pending patent application entitled “SYSTEM AND METHOD FOR OPTIMIZING THE ROUTING OF MULTIMEDIA CONTENT”, by R. B. Hubbard (Atty. Docket No. Hubbard-3), the teachings of which are incorporated herein by reference.

Thus, the present invention has been described herein with reference to a particular embodiment for a particular application. Those having ordinary skill in the art and access to the present teachings will recognize additional modifications, applications and embodiments within the scope thereof. For example, while the invention has been described with reference to an application for delivering advertisements to cellular phones, the present teachings may also used for delivering other types of multimedia content or for delivering to other types of media storage devices.

It is therefore intended by the appended claims to cover any and all such applications, modifications and embodiments within the scope of the present invention.

Accordingly,

What is claimed is:

1. A system for optimizing the delivery of multimedia content to subscribers' devices comprising:
first means for obtaining data on subscribers' actions on said devices and second means for recommending a delivery solution for new content based on said data.

2. The invention of claim 1 wherein said solution includes identification of which subscribers should be sent said new content.

3. The invention of claim 2 wherein said data includes subscribers' responses to content previously delivered to said subscribers' devices.

4. The invention of claim 3 wherein said second means includes means for predicting how subscribers will respond to said new content based on said responses.

5. The invention of claim 4 wherein said second means further includes means for identifying subscribers predicted to have a positive response to said new content.

6. The invention of claim 5 wherein said second means further includes means for identifying one or more subgroups of subscribers predicted not to have a positive response to said new content.

7. The invention of claim 6 wherein said second means further includes means for recommending one or more modifications to said new content for said subgroups, wherein said modifications are predicted to improve how subscribers in said subgroups will respond to said new content.

8. The invention of claim 1 wherein said second means includes a neural network artificial intelligence engine.

9. The invention of claim 1 wherein said second means includes a provider-side sub-system for presenting a content provider with information about behavior patterns of said subscribers and recommendations for maximizing predicted subscriber acceptance of said new content.

10. The invention of claim 9 wherein said first means includes a subscriber-side sub-system for generating and maintaining profiles on a plurality of subscribers.

11. The invention of claim 10 wherein said first means further includes a database for storing said profiles.

12. The invention of claim 10 wherein said first means further includes an applet stored in and executed by each device adapted to record a subscriber's actions on said device.

13. The invention of claim 12 wherein said subscriber-side sub-system is adapted to receive said recorded actions from said applets and update said subscriber profiles accordingly.

14. The invention of claim 13 wherein said subscriber-side sub-system is adapted to automatically refine a subscriber's personal preferences stored in said subscriber's profile based on said subscriber's responses to previously viewed content.

15. The invention of claim 14 wherein said provider-side sub-system is adapted to analyze said profiles to predict how said subscribers will respond to said new content.

16. The invention of claim 1 wherein said system further includes means for identifying an optimal time for scheduling playback of said new content based on said monitored actions.

17. The invention of claim 1 wherein said content includes advertisements.

18. The invention of claim 1 wherein said devices include cellular phones.

19. A system for optimizing the delivery of multimedia content to subscribers' media storage devices comprising:
an applet stored in and executed by each media storage device adapted to record a subscriber's actions on said media storage device and
a server-side system including:
a first sub-system for receiving said recorded actions from said applets and
a second sub-system for recommending a delivery solution for new content based on said recorded actions.

20. A system for delivering multimedia content to subscribers' media storage devices comprising:
a database for storing profiles on a plurality of subscribers;
an applet stored in and executed by each of said subscribers' media storage devices adapted to record a subscriber's actions on said device;
a subscriber-side sub-system for receiving said recorded actions from said applets and updating said profiles accordingly;
a provider-side sub-system for selecting subscribers to receive new content based on said profiles; and
a delivery sub-system for delivering said new content to each selected subscriber's media storage device.

21. A method for optimizing the delivery of multimedia content to subscribers' devices including the steps of:
obtaining data on subscribers' actions on said devices and
recommending a delivery solution for new content based on said data.
